(19) United States
(12) Patent Application Publication
(10) Pub. No.: US 2025/0013588 A1
(43) Pub. Date: Jan. 9, 2025

(54) SYSTEM AND METHOD FOR VERIFYING AN INPUT/OUTPUT OPERATION OF AN AUTOSAR PLATFORM IN A VIRTUAL ECU ENVIRONMENT

(71) Applicant: DRIMAES, INC., Daegu (KR)

(72) Inventors: An Na YANG, Seongnam-si (KR); Woo Jin Han, Seoul (KR); Woo Hyun Seol, Seoul (KR); In Ho Lee, Seoul (KR); Ji Su Kong, Seoul (KR)

(73) Assignee: DRIMAES, INC., Daegu (KR)

(21) Appl. No.: 18/762,176

(22) Filed: Jul. 2, 2024

(30) Foreign Application Priority Data
Jul. 4, 2023 (KR) 10-2023-0086166

(51) Int. Cl. G06F 13/20

(52) U.S. Cl. CPC G06F 13/20

(57) ABSTRACT

Provided is a method for verifying an input/output operation of an AUTOSAR platform in a virtual ECU environment. The method includes transmitting an input/output command for a peripheral implemented in a core area of the virtual ECU from an AUTOSAR platform area of the virtual ECU operating in a virtual environment to a memory area through a predetermined emulator; transmitting the input/output command from the memory area to the peripheral; and performing a read or write operation of data on a register of the peripheral by emulating an operation corresponding to the input/output command in the peripheral.

### CROSS-REFERENCE TO RELATED APPLICATION

THIS APPLICATION CLAIMS PRIORITY TO AND THE BENEFIT OF KOREAN PATENT APPLICATION NO. 10-2023-0086166, FILED ON Jul. 4, 2023, THE DISCLOSURE OF WHICH IS INCORPORATED HEREIN BY REFERENCE IN ITS ENTIRETY.

### BACKGROUND

### 1. Technical Field

The present invention relates to a system and method for verifying an input/output operation of an autosar platform in a virtual ECU environment.

### 2. Related Art

AUTOSAR (classic platform) is an abbreviation for Automotive Open System Architecture (hereinafter referred to as AUTOSAR), and is an open standard platform used for automotive software development. The AUTOSAR standardizes the software architecture and communication of a vehicle control unit (hereinafter referred to as ECU) to promote compatibility and reuse between various companies and devices.

In the case of the related art, methods such as imitating external peripheral signals or reconfiguring communication between software and peripherals were used to verify the operation of software in an actual automobile system.

However, this method had problems that it takes a lot of time, manpower, etc., to develop and configure an interface between the software and the peripheral, and that it is difficult to perfectly emulate the operation of the actual automobile system.

In addition, there was also the problem of costing a lot of money to reconfigure the software for input/output analysis for specific scenarios.

### SUMMARY

A problem to be solved by the present invention is to provide a system and method for verifying operation according to input and output of an AUTOSAR platform in a virtual ECU environment, capable of performing verification of the input and output by emulating the input and output of data through a peripheral register management of the virtual ECU in driving and verifying an automotive embedded system configured according to AUTOSAR standards on the virtual ECU.

However, the problem to be solved by the present invention is not limited to the problem described above, and other problems may be present.

According to a first aspect of the present invention to solve the above problem, a method for verifying an input/output operation of an AUTOSAR platform in a virtual ECU environment includes: transmitting an input/output command for a peripheral implemented in a core area of the virtual ECU from an AUTOSAR platform area of the virtual ECU operating in a virtual environment to a memory area through a predetermined emulator; transmitting the input/output command from the memory area to the peripheral; and performing a read or write operation of data on a register of the peripheral by performing an operation emulation corresponding to the input/output command in the peripheral.

In addition, according to a second aspect of the present invention, a system for verifying an input/output operation of an AUTOSAR platform in a virtual ECU environment includes: an AUTOSAR platform area that is implemented on the virtual ECU operating in a virtual environment through a predetermined emulator; a memory area that is implemented on the virtual ECU, and as an input/output command transmitted from the AUTOSAR platform area is received through the memory area, a peripheral that is implemented in a core area of the virtual ECU performing a read or write operation of data on a register of a peripheral by performing an operation emulation corresponding to the input/output command.

In addition, the system for verifying an input/output operation of an AUTOSAR platform in a virtual ECU environment according to the second aspect of the present invention includes a memory configured to store at least one instruction, and at least one processor configured to execute the instructions stored in the memory. In this case, as the processor executes the instructions stored in the memory, the processor generates an AUTOSAR platform area on the virtual ECU operating in a virtual environment through a predetermined emulator, generates a memory area on the virtual ECU, and as an input/output command transmitted from the AUTOSAR platform area is received through the memory area, generates a peripheral in a core area of the virtual ECU performing a read or write operation of data on a register of a peripheral by emulating an operation corresponding to the input/output command.

In addition, a computer program according to another aspect of the present invention is combined with a computer as hardware to execute the method for verifying an input/output operation of an AUTOSAR platform in the virtual ECU environment, and is stored in a computer-readable recording medium.

Other specific details of the present invention are contained in the detailed description and drawings.

According to the present invention described above, by directly manipulating the peripheral register management of the virtual ECU to emulate the input and output, it is possible to omit the configuration or function of the device interface. Accordingly, it is possible to use for the test and verification assuming various inputs and outputs, such as General Purpose Input/Output (GPIO), Serial Peripheral Interface (SPI), Inter-Integrated Circuit (I2C), and the display.

In addition, by omitting the device interface configuration, it is possible to reduce the time and cost required for the development and management and to provide the more flexible test and verification environment.

The effects of the present disclosure are not limited to the effects described above, and other effects not described will be obviously understood by those skilled in the art from the following description.

### BRIEF DESCRIPTION OF THE DRAWINGS

FIG. 1 is a diagram showing a configuration of an automotive embedded system to be verified in an embodiment of the present invention.

FIG. 2 is a diagram for describing a configuration of a virtual ECU using QEMU.

FIG. 3 is a diagram for describing a memory read operation on the virtual ECU.

FIG. 4 is a diagram for describing a memory write operation on the virtual ECU.

FIG. 5 is a diagram for describing a process of processing input of data transmitted from a host PC in the related art.

FIG. 6 is a diagram for describing a process of outputting data to the host PC in the related art.

FIG. 7 is a flowchart of a method performed by a system for verifying an input/output operation of an AUTOSAR platform according to an embodiment of the present invention.

FIG. 8A is a diagram for describing the process of emulating the external input process in an embodiment of the present invention.

FIG. 8B is a diagram for describing the process of emulating the external input process through an example of GPIO in an embodiment of the present invention.

FIG. 9 is a diagram for describing a process of emulating an external output process in an embodiment of the present invention.

FIG. 10 is a configuration diagram of the system for verifying an input/output operation of an AUTOSAR platform according to an embodiment of the present invention.

### DETAILED DESCRIPTION

The advantages and features of the present invention and a method for achieving them will become apparent by referring to the embodiments described in detail below along with the accompanying drawings. However, the present invention is not limited to the embodiments to be disclosed below, but may be implemented in various different forms. The present embodiments will be provided only to make the disclosure of the present invention complete and allow those skilled in the art to completely recognize the scope of the present invention, and the present invention will be only defined by the scope of the claims.

The terms used in the present specification are for explaining the embodiments rather than limiting the present invention. In the present specification, a singular form includes a plural form unless specially stated in the phrase. The terms “comprises” and/or “comprising” used herein do not preclude the presence or addition of one or more other components in addition to the mentioned component. Like reference numerals throughout the specification refer to like components and “and/or” includes each and all combinations of one or more components. Although “a first”, “a second” and the like are used to describe various components, these components are of course not limited by these terms. These terms are used only to distinguish one component from other components. Therefore, it is natural that a first component mentioned below may also be a second component within the technical idea of the present invention.

Unless defined otherwise, all terms (including technical and scientific terms) used in the present specification will be used as a meaning that can be commonly understood by those skilled in the art to which the present invention pertains. In addition, the terms defined in commonly used dictionary are not ideally or excessively interpreted unless explicitly and specially defined.

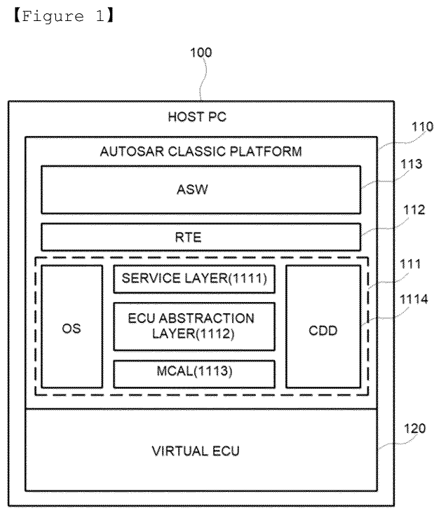

FIG. 1 is a diagram showing a configuration of an automotive embedded system to be verified in an embodiment of the present invention.

An embodiment of the present invention is to verify an automotive embedded system having a structure as shown in FIG. 1, and is to drive and verify an automotive embedded system configured according to the AUTOSAR classic standard, a representative automotive embedded system standard, on a virtual ECU implemented using a Quick Emulator (QEMU). In this case, an embodiment of the present invention aims to verify the input/output of the automotive embedded system.

Meanwhile, an automotive embedded system 100, which is a subject of verification shown in FIG. 1, includes a virtual ECU 120 and an AUTOSAR platform 110.

At least one virtual ECU 120 may be generated on a host PC as a predetermined virtualization library is executed. The virtual ECU 110 may execute firmware applied with the AUTOSAR platform, like a structure of a general vehicle system guided by AUTOSAR, and the AUTOSAR platform 110 includes Basic Software (BSW) 111, a Runtime Environment (RTE) 112, and Application Software (ASW) 113.

The ASW 113 is an application software layer and is a set of software components. The ASW 113 is a software component, and implements core functions unique to a controller to be developed by OEMs, suppliers, etc.

The RTE 112 serves to exchange and connect data between components of the ASW 113 and between the ASW 113 and the BSW 111. The RTE 112 allows software components implemented in the ASW 113 through the RTE 112 to be used through an API call without any modification.

The BSW 111 separates hardware and software and serves to provide independent application services to hardware. That is, the BSW 111 is a standardized software layer that provides services necessary for software components to perform necessary tasks, and provides services related to input/output, memory, and communication to software components.

Specifically, among AUTOSAR layers, BSW 111 largely includes a service layer 1111, an ECU abstraction layer 1112, a Microcontroller Abstraction Layer (MCAL) 1113, and Complex Device Drivers (CDD) 1114.

The service layer 1111 is the uppermost layer among the BSW 111 layers, and provides system services, memory services, communication services, and the like for system operation and overall control of other modules in the BSW 111.

In this case, the system service performs a function of managing tasks and interrupts. The memory service performs functions for reading and writing to a memory. The communication service provides functions necessary to use various communication protocols in an automotive embedded system. According to an embodiment, the service layer 1111 may be shown as including an OS.

Next, the ECU abstraction layer 1112 provides an ECU-independent interface to a service layer and an ASW layer. As an embodiment, various memory interfaces and communication interfaces may be implemented according to the ECU through the ECU abstraction layer 1112.

Next, the MCAL 1113 provides a microcontroller-independent specific interface to the abstraction layer. When the AUTOSAR is applied to a microcontroller with a different design, it is possible to call communication, memory, and input/output modules regardless of the microcontroller by using a driver of the MCAL 1113.

Finally, the CDD 1114 is a layer that configures a direct interface from the microcontroller to RTE without being connected to the specific layer, and may allow information of the BSW 111 to be directly transmitted to the ASW 113 through the RTE 112. The CDD 1114 may be used by adding a driver or the like for functions not defined in the AUTOSAR. In an embodiment of the present invention, the virtual ECU 120 may use the function of the CDD 1114 to update the memory area of the virtual ECU 120, thereby emulating various inputs such as Digital Input/Output (DIO)) and Inter-Integrated Circuit (I2C), and Serial Peripheral Interface (SPI). As data related to various inputs and outputs is updated in the memory area, the operation of the automotive embedded system 100 may be verified.

FIG. 2 is a diagram for describing a configuration of a virtual ECU 220 using QEMU.

In an embodiment of the present invention, a target ECU 220 for driving the AUTOSAR classic platform 210 was implemented using QEMU, an open source emulator that emulates various hardware architectures in a virtual environment.

The QEMU provides a virtual environment based on STM32 microcontrollers such as STM32F205 and STM32F405C, and in the present invention, the virtual ECU 220 compatible with STM32F407zgt was reconfigured using the virtual environment.

FIG. 2 illustrates the configuration of the QEMU for emulating the STM32F407vgt, and the virtual ECU 220 may include a core 221, a memory manager 222, and a device interface 223.

The core 221 may include an emulator 2211 and a peripheral 2212. The emulator 2211 may emulate an operation of, for example, an armv7-based core and may be provided in the QEMU. The emulator 2211 may access an address for the firmware operation, execute the code, and update a memory according to the results. The peripheral 2212 manages an input/output state along with the operation emulation for each input and output. The state and availability of a read only register and a write only register such as the read and write for a specific peripheral are managed.

Here, the operation emulation of the peripheral 2212 refers to simulating an operation of a specific peripheral in the virtual environment by emulating the actual peripheral operation in the virtual ECU. In other words, the operation emulation refers to an operation of reading and writing a specific register value so that the virtual ECU 220 may interact with the actual peripheral.

The memory manager 222 has commands for firmware operation on the core 221, registers memory for each peripheral 2212, and stores the state of the peripheral 2212.

The device interface 223 is implemented in the form of a bus and exchanges data between a host PC 200 and the virtual ECU 220 through an interface implemented in the form of a peripheral bus. In this case, according to an embodiment of the present invention, when verifying the input/output operation of the AUTOSAR platform 210, the device interface 223 is not either provided or used. This will be described in detail in the description part of the present invention.

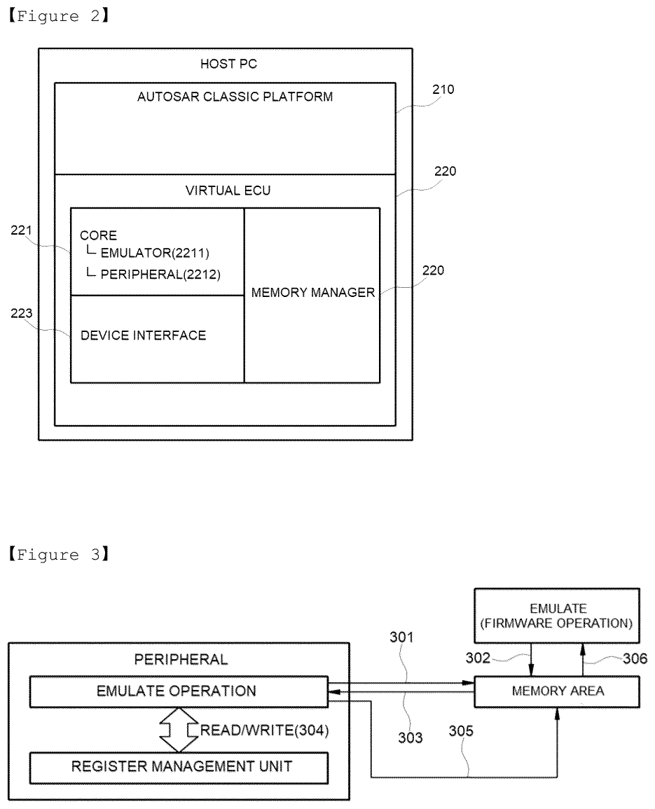

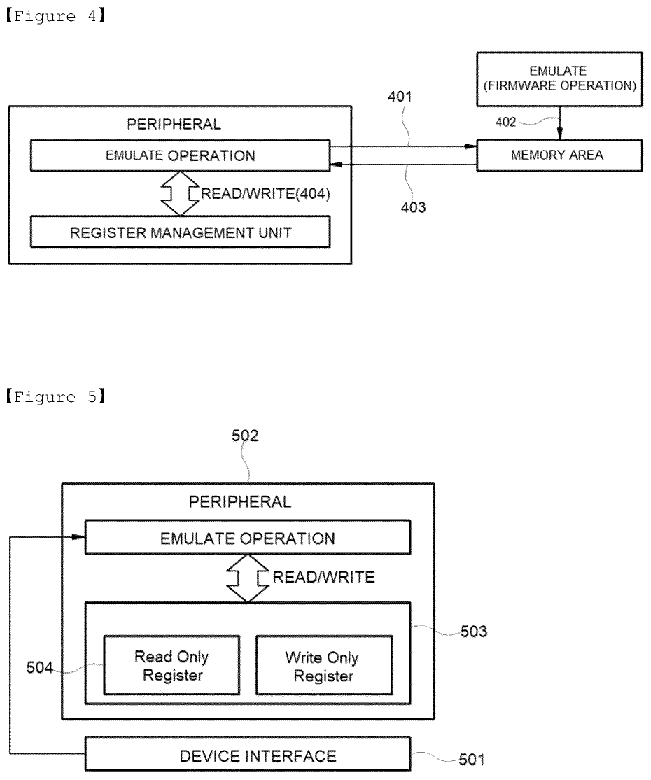

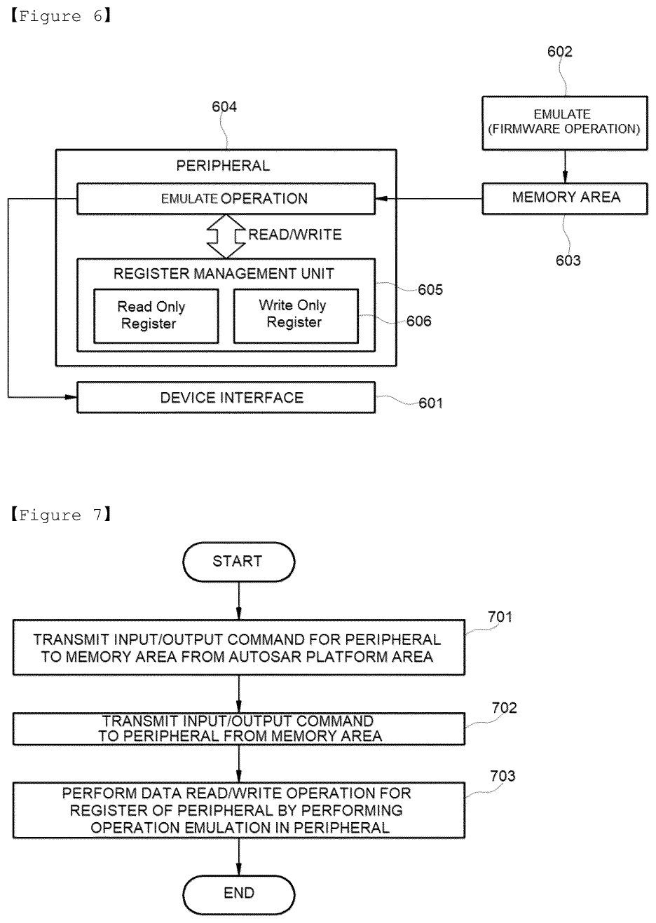

Hereinafter, the read and write operations of the memory on the virtual ECU applied to the present invention will be described with reference to FIGS. 3 and 4, the related art will be described with reference to FIGS. 5 and 6, and then the present: invention will be described in detail below with reference to FIG. 7.

FIG. 3 is a diagram for describing a memory read operation on the virtual ECU.

FIG. 3 illustrates a procedure for reading a status value of a register management unit of the peripheral when driving the virtual ECU. First, as an initialization operation, addresses for each peripheral are registered in the memory and memory areas for each peripheral are assigned (301).

Next, when the firmware requests a status value corresponding to a specific peripheral, that is, transmits a read operation command (302), the memory requests the peripheral to perform an operation emulation to read the value of the corresponding register through the peripheral in response to the read operation command (303).

Next, the peripheral reads a specific register value by emulating the same operation as the actual peripheral (304), and then returns the read register value to the memory and stores the read register value (305).

Next, the register value stored in the memory returns to the firmware, and the returned status value may be used for verification in the firmware (306).

FIG. 4 is a diagram for describing a memory write operation on the virtual ECU.

FIG. 4 illustrates a procedure for writing values corresponding to each peripheral in the register according to the operation of the firmware. First, before the firmware is executed, the addresses for each peripheral are registered in the memory and necessary resources are assigned (401). Through this, the memory areas for each peripheral may be set.

Next, the firmware requests to write a value to a register for a specific peripheral (402), and transmits the write operation command to the peripheral to write data to be output by performing the operation emulation of the peripheral in the memory area in response to the command (403).

Next, the peripheral emulates the operation of each peripheral and writes the status value that each peripheral should have to the register (404).

In this way, the input/output verification in operation control, status monitoring, interaction, communication, etc., of each peripheral is possible through the memory read and write operations on the virtual ECU.

FIG. 5 is a diagram for describing a process of processing input of data transmitted from the host PC in the related art. FIG. 6 is a diagram for describing a process of outputting data to the host PC in the related art.

In the related art, data is input and output through a device interface, and the data is processed by calling the operation emulation of the peripheral.

When data is input to a device interface 501, the device interface 501 calls the operation emulation of a peripheral 502 and stores the data in a register management unit 503. The value of the peripheral stored in the register management unit 503 is stored in a read only register 504 of the register management unit 503 until the peripheral 502 is read from the memory area. This is to temporarily store the status value of the peripheral 502.

In addition, in the case of outputting data through the device interface 601, when the firmware outputs data to the host PC through a specific peripheral, the firmware 602 may command to write a specific signal to a register through the memory area 603, read a value stored in a specific write only register 606 of the register management unit 605 through a process of emulating the operation of the peripheral 604, and transmit the read value to the host PC through the device interface 601. This allows data to be output from the peripheral 604 to the host PC.

Such a related art uses the device interface as an intermediary to process the input and output of data. In other words, when data is input, the device interface serves to call the operation emulation of the peripheral and store the called operation emulation in the register, and when data is output, the device interface allows the data to be transmitted to the host PC through a specific peripheral.

This device manager may be configured by specifying file or socket communication and input for each peripheral on a one-to-one basis to build the QEMU.

However, in the case of the related art, when the automotive embedded system automatically generates a signal according to a specific scenario and verifies the operation of the corresponding software, the software for the input/output analysis should be separately reconfigured externally, and there is a problem that it takes a lot of additional time and manpower to verify the operation.

In contrast, in an embodiment of the present invention, the following effects may be expected by omitting the device interface.

First, the time and manpower required for separate configuration of the device interface and the interface development may be saved. In other words, an embodiment of the present invention has the advantage of eliminating the need to separately configure the device interface by arbitrarily manipulating the status value of the register through the management of the peripheral register of the virtual ECU, thereby either generating a signal or emulating a signal as if it were generated within the virtual ECU.

Second, an embodiment of the present invention has the advantage of being able to more freely manipulate the operation of the virtual ECU and more easily reproduce various scenarios by omitting the device interface. In other words, the operation of the vehicle embedded system may be quickly and easily tested by emulating the desired input and verifying the output depending on the specific situation. For example, it may be used for testing and verification assuming various inputs and outputs such as GPIO, SPI, I2C, and display.

Third, in an embodiment of the present invention, unlike developing and configuring separate software for the input/output analysis on a specific scenario in an actual automobile system, which takes a lot of time and cost, by verifying the input and output of data within the virtual environment, that is, the virtual ECU, it is possible to reduce costs and safely conduct the testing and verification.

FIG. 7 is a flowchart of a method performed by a system for verifying an input/output operation of an AUTOSAR platform according to an embodiment of the present invention.

In an embodiment of the present invention, the CDD exists as a layer that directly configures the interface from the microcontroller to the RTE without being mapped to a specific layer in the AUTOSAR classic platform.

The present invention implements an application example for verifying the input and output of a virtual ECU in the CDD, so that the role of the device interface may be performed on the automotive embedded software.

In this case, the application example of the CDD may artificially manipulate the memory operation on the virtual ECU to perform the operations such as writing a value to the read only register or reading a value to the write only register through the operation emulation.

Meanwhile, the application example of the CDD may be implemented using a library from STMicroelectronics (ST) company.

The method for verifying an AUTOSAR platform input/output operation according to an embodiment of the present invention first transmits the input/output command for the peripheral implemented in the core area of the virtual ECU from the AUTOSAR platform area of the virtual ECU operating in a virtual environment to the memory area through a predetermined emulator (701).

Next, the input/output command is transmitted from the memory area to the peripheral (702).

Next, the read or write operation of the data on the register of the peripheral is performed by emulating the operation corresponding to the input/output command in the peripheral (703).

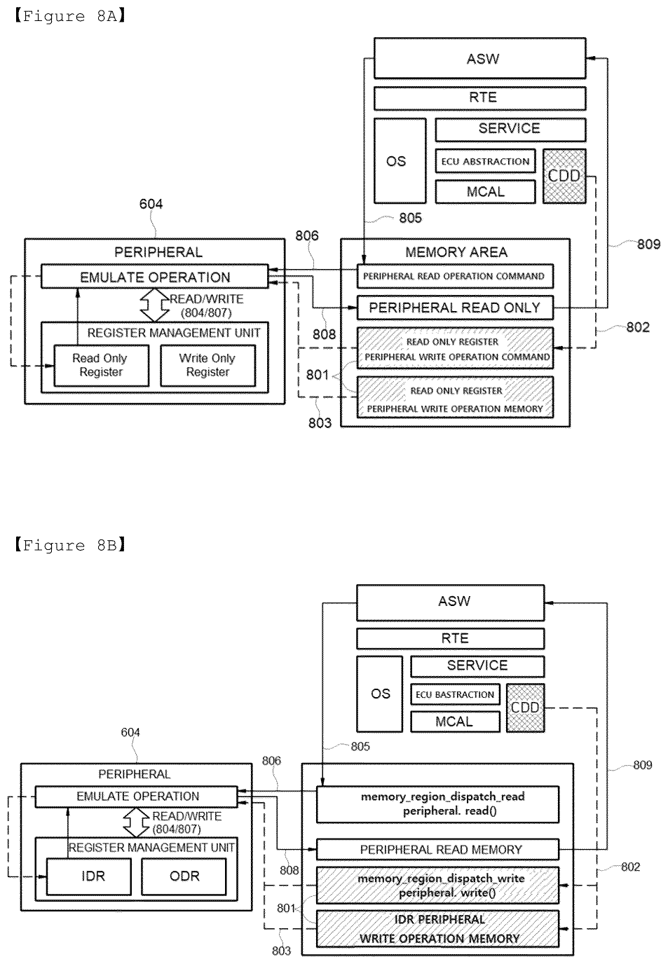

Hereinafter, the read operation and write operation of data in an embodiment of the present invention will be described in more detail with reference to FIGS. 8A and 8B.

FIG. 8A is a diagram for describing the process of emulating the external input process in an embodiment of the present invention. FIG. 8B is a diagram for describing the process of emulating the external input process through an example of GPIO in an embodiment of the present invention.

First, the operation information for the write operation of the read only register of the peripheral on the memory area is implemented and mapped through the CDD of the AUTOSAR platform area (801).

Next, the command for the write operation of the read only register and the data for the write operation are transmitted from the CDD to the memory area (802).

The command for the write operation of the read only register transmitted to the memory area and the data for the write operation are transmitted to the peripheral (803), and the peripheral performs the operation emulation according to the command to perform the write operation (804).

Next, according to the operation emulation, the peripheral enters a standby state as the write operation of data on the read only register is completed.

In this case, when the ASW wants to perform the read command for the peripheral, the ASW in the AUTOSAR platform area transmits the read command for the peripheral to the memory area by sequentially passing through the RTE, the service layer, the ECU abstraction layer, and the MCAL (805).

In the MCAL, an XXPeripheral_read only register_REGISTER_READ command is executed, so the peripheral read operation command in the memory area may be performed.

As the peripheral receives the read command for the peripheral from the memory area (806), the peripheral performs the operation emulation, and reads the data written according to the write operation according to step 850 on the read only register (807).

Next, the read data is stored on the peripheral read memory of the memory area (808), and the data stored on the peripheral read memory is transmitted to the AUTOSAR platform area (809). In this case, the stored data is transmitted to the ASW again by passing through the MCAL, the ECU abstraction layer, the service layer, and the RTE.

Through this processing process, an embodiment of the present invention may perform the write operation on the read only register of the peripheral using the CDD.

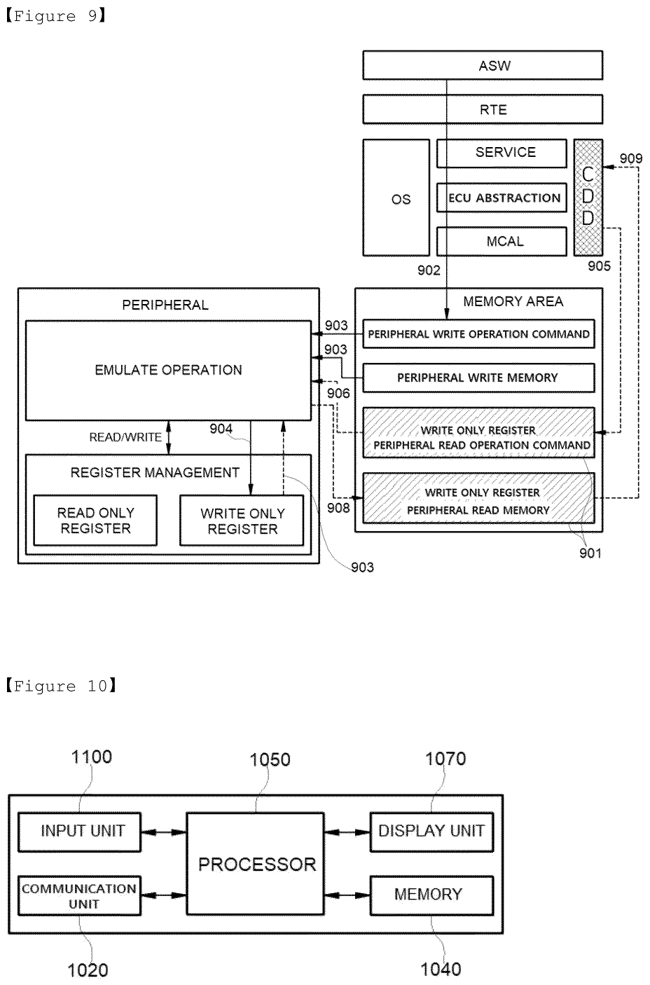

FIG. 9 is a diagram for describing a process of emulating an external output process in an embodiment of the present invention.

First, the operation information for the read operation of the write only register of the peripheral on the memory area is implemented and mapped through the CDD of the AUTOSAR platform area (901).

Next, the write command for the peripheral is transmitted from the ASW in the AUTOSAR platform area to the memory area by sequentially passing through the RTE service layer, the ECU abstraction layer, and the MCAL (902).

Next, when the memory area transmits the write command and data to the peripheral (903), the peripheral performs the operation emulation to perform the write operation on the data to be output on the write only register (904).

Next, the CDD in the AUTOSAR platform area transmits the command for the read operation of the write only register to the memory area (905), and the memory area transmits the command for the read operation of the write only register to the peripheral (906).

Next, the peripheral performs the operation emulation according to the command for the read operation and reads the data written on the write only register according to the operation emulation (907).

Next, the peripheral stores the read data on the peripheral read memory for the write only register of the memory area (908), and transmits the data stored on the peripheral read memory to the AUTOSAR platform area (909). In this case, the stored data is transmitted to the ASW again by passing through the MCAL, the ECU abstraction layer, the service layer, and the RTE.

Thereafter, the CDD in the AUTOSAR platform area logs data according to the operation in the ASW, and compares the data with the pre-stored test results in the ASW to record verification success, verification failure, or the like for the operation.

Meanwhile, in the above description, steps 701 to 909 may be further divided into additional steps or combined into fewer operations according to an implementation example of the present invention. Also, some operations may be omitted if necessary, and an order between operations may be changed. In addition, even if other contents are omitted, the contents described in FIGS. 1 to 6 and 10 and the contents described in FIGS. 7 to 9 are mutually applied.

FIG. 10 is a configuration diagram of a system 1000 for verifying an input/output operation of an AUTOSAR platform according to an embodiment of the present invention.

Referring to FIG. 10, the system 1000 for verifying an input/output operation of an AUTOSAR platform 1000 includes an input unit 1010, a communication unit 1020, a display unit 1030, a memory 1040, and a processor 1050.

The input unit 1010 receives a predetermined input value for operating the system 1000 for verifying an input/output operation of an AUTOSAR platform from a user. The input unit 1010 includes at least one input means. The input unit 1010 may include a keyboard, a key pad, a dome switch, a touch panel, a touch key, a mouse, a menu button, and the like.

The communication unit 1020 supports transmission and reception of internal data or external data of the system 1000 for verifying an input/output operation of an AUTOSAR platform.

This communication unit 1020 may include both a wired communication module and a wireless communication module. The wired communication module may be implemented as a power line communication device, a telephone line communication device, cable home (MoCA), Ethernet, IEEE1294, an integrated wired home network, and an RS-485 control device. In addition, the wireless communication module may be configured in a module for implementing functions such as wireless LAN (WLAN), Bluetooth, HDR WPAN, UWB, ZigBee, Impulse Radio, 60 GHz WPAN, Binary-CDMA, wireless USB technology and wireless HDMI technology, 5th generation (5G) communication, long term evolution-advanced (LTE-A), long term evolution (LTE), and wireless fidelity (Wi-Fi).

A display unit 1030 outputs data according to the operation of the system 1000 for verifying an input/output operation of an AUTOSAR platform, displays other usage service screens, or the like. The display unit 1030 may include a liquid crystal display (LCD), a light emitting diode (LED) display, an organic LED (OLED) display, a micro electro mechanical systems (MEMS) display, and an electronic paper display. The display unit 1030 may be coupled with the input unit 1010 and implemented as a touch screen.

The memory 1040 stores operation programs of the system 1000 for verifying an input/output operation of an AUTOSAR platform. Here, the memory 1040 collectively refers to a non-volatile storage device that continuously maintains stored information even when power is not supplied and a volatile storage device. For example, the memory 120 may include NAND flash memories such as a compact flash (CF) card, a secure digital (SD) card, a memory stick, a solid-state drive (SSD), and a micro-SD card, magnetic computer storage devices such as a hard disk drive (HDD), and optical disc drives such as CD-ROM, DVD-ROM, etc.

The processor 1050 may control at least one other component (e.g., hardware or software component) of the system 1000 for verifying an input/output operation of an AUTOSAR platform by executing software, such as a program stored in memory, and perform various data processing or calculations.

In an embodiment of the present invention described above, the method for verifying an input/output operation of an AUTOSAR platform in a virtual ECU environment may be implemented as a program (or application) and stored in a medium to be executed in combination with a computer which is hardware.

In order for the computer to read the program and execute the methods implemented as the program, the aforementioned program may include a code coded in a computer language such as C, C++, JAVA, Ruby, Python or machine language that the processor (CPU) of the computer may read through a device interface of the computer. This code may include functional codes related to a function defining functions necessary for executing the methods and control codes related to an execution procedure necessary for the processor of the computer to execute the functions according to a predetermined procedure. In addition, this code may further include a memory reference-related code that indicates which location (address street number) in an internal or external memory of the computer should be referenced for additional information or media necessary for the processor of the computer to execute the functions. In addition, when the processor of the computer needs to communicate with any other remote computers, servers, or the like in order to execute the above functions, the code may further include a communication-related code for how to communicate with any other remote computers, servers, or the like using the communication module of the computer, what information or media should be transmitted and received during communication, and the like.

The storage medium refers to a medium that stores data semi-permanently and can be read by a device, rather than a medium that stores data for a short period of time, such as a register, a cache, a memory, or the like. Specifically, examples of the storage medium include, but are not limited to, ROM, RAM, CD-ROM, a magnetic tape, a floppy disk, an optical data storage device, and the like. That is, the program may be stored in various recording media on various servers accessible by the computer or in various recording media on the computer of the user. In addition, the media may be distributed to a computer system connected by a network, and a computer-readable code may be stored in a distributed manner.

The aforementioned description of the present invention is for illustrative purposes, and those skilled in the art to which the present invention pertains will understand that it may be easily modified to other specific forms without changing the technical idea or essential features of the present invention. Therefore, it should be understood that the embodiments described above are illustrative in all aspects and not restricted. For example, each component described as a single type may be implemented in a distributed manner, and similarly, components described as distributed may also be implemented in a combined form.

It is to be construed that the scope of the present invention is indicated by the claims described below rather than the detailed description above, and all modifications and alternations derived from the meaning and scope of claims and their equivalent concept are included in the scope of the present invention.

What is claimed is:

1. A method for verifying an input/output operation of an automotive open system architecture (AUTOSAR) platform in a virtual electronic control module (ECU) environment performed by a computer, the method comprising:
transmitting an input/output command for a peripheral implemented in a core area of a virtual ECU from an AUTOSAR platform area of the virtual ECU operating in a virtual environment to a memory area through a predetermined emulator;
transmitting the input/output command from the memory area to the peripheral; and
performing a read or write operation of data on a register of the peripheral by emulating an operation corresponding to the input/output command in the peripheral.

2. The method of claim 1, further comprising implementing and mapping operation information for a write operation of a read only register of the peripheral on the memory area through a complex device driver (CDD) of the AUTOSAR platform area.

3. The method of claim 2, further comprising:
before transmitting the input/output command for the peripheral, transmitting the command for the write operation of the read only register and the data for the write operation from the CDD of the AUTOSAR platform area to the memory area;
performing the operation emulation according to the command for the write operation in the peripheral; and
switching to a standby state as the write operation of the data on the read only register is completed according to the operation emulation.

4. The method of claim 3, wherein in the transmitting of the input/output command for the peripheral implemented in the core area of the virtual ECU from the AUTOSAR platform area to the memory area, a read command for the peripheral is transmitted from an ASW of the AUTOSAR platform area to the memory area by sequentially passing through RTE, a service layer, an ECU abstraction layer, and MCAL.

5. The method of claim 4, wherein the performing of the read or write operation of the data on the register of the peripheral by emulating the operation corresponding to the input/output command in the peripheral includes:
performing the operation emulation and reading the data written according to the write operation on the read only register as the peripheral receives the read command for the peripheral from the memory area;
storing the read data on a peripheral read memory of the memory area; and
transmitting data stored on the peripheral read memory to the AUTOSAR platform area.

6. The method of claim 1, further comprising implementing and mapping operation information for a read operation of a write only register of the peripheral on the memory area through the CDD of the AUTOSAR platform area.

7. The method of claim 6, wherein in the transmitting of the input/output command for the peripheral implemented in the core area of the virtual ECU from the AUTOSAR platform area to the memory area, a write command for the peripheral is transmitted from an application software (ASW) of the AUTOSAR platform area to the memory area by sequentially passing through a runtime environment (RTE), a service layer, an electronic control unit (ECU) abstraction layer, and a microcontroller abstraction layer (MCAL).

8. The method of claim 7, wherein in the performing of the read or write operation of the data for the register of the peripheral by emulating the operation corresponding to the input/output command in the peripheral, as the peripheral receives the write command for the peripheral from the memory area, the write operation on data to be output on the write only register is performed by performing the operation emulation.

9. The method of claim 8, further comprising:
after performing the read or write operation of the data on the register of the peripheral, transmitting the command for the read operation of the write only register from the CDD of the AUTOSAR platform area to the memory area;
performing the operation emulation according to the command for the read operation in the peripheral;
reading data written on the write only register according to the operation emulation;
storing the read data on a peripheral read memory for the write only register of the memory area; and
transmitting the data stored on the peripheral read memory to the AUTOSAR platform area.

10. The method of claim 9, further comprising:
logging the data according to the operation in the ASW in the CDD of the AUTOSAR platform area; and
verifying the operation in the ASW by comparing the data with a pre-stored test result.

11. A system for verifying an input/output operation of an automotive open system architecture (AUTOSAR) platform in a virtual electronic control unit (ECU) environment, the system comprising:
an AUTOSAR platform area that is implemented on the virtual ECU operating in a virtual environment through a predetermined emulator;
a memory area that is implemented on the virtual ECU; and
as an input/output command transmitted from the AUTOSAR platform area is received through the memory area, a peripheral that is implemented in a core area of the virtual ECU performing a read or write operation of data on a register of a peripheral by emulating an operation corresponding to the input/output command.

12. The system of claim 11, wherein a complex device driver (CDD) of the AUTOSAR platform area implements and maps operation information for a write operation of a read only register of the peripheral on the memory area.

13. The system of claim 12, wherein before transmitting the input/output command to the peripheral, the CDD in the AUTOSAR platform area transmits a command for a write operation of the read only register and data for the write operation to the memory area,
performs the operation emulation according to the command for the write operation in the peripheral, and
switches to a standby state as the write operation of the data on the read only register is completed according to the operation emulation.

14. The system of claim 13, wherein the read command for the peripheral is transmitted from an application software (ASW) of the AUTOSAR platform area to the memory area by sequentially passing through a runtime environment (RTE), a service layer, an ECU abstraction layer, and a microcontroller abstraction layer (MCAL).

15. The system of claim 14, wherein as the peripheral receives a read command for the peripheral from the memory area, the peripheral performs the operation emulation to read the data written according to the write operation on the read only register, stores the read data on the peripheral read memory of the memory area, and then transmits the data stored on the peripheral read memory to the AUTOSAR platform area.

16. The system of claim 11, wherein the CDD in the AUTOSAR platform area implements and maps operation information for a read operation of the write only register of the peripheral on the memory area.

17. The system of claim 16, wherein the write command for the peripheral is transmitted from ASW of the AUTOSAR platform area to the memory area by sequentially passing through RTE, a service layer, an ECU abstraction layer, and MCAL.

18. The system of claim 17, wherein as the write command for the peripheral is received from the memory area, the peripheral performs the operation emulation and performs a write operation on data to be output on the write only register.

19. The system of claim 18, wherein after performing the read or write operation of data on the register, the peripheral transmits a command for the read operation of the write only register from the CDD in the AUTOSAR platform area to the memory area,
performs the operation emulation according to the command for the read operation,
reads data written on the write only register according to the operation emulation, and stores read data on a peripheral read memory for the write only register in the memory area, and
transmits data stored on the peripheral read memory to the AUTOSAR platform area.

20. A system for verifying an input/output operation of an automotive open system architecture (AUTOSAR) platform in a virtual electronic control unit (ECU) environment, the system comprising:
a memory configured to store at least one instruction; and
at least one processor configured to execute the instructions stored in the memory,
wherein, as the processor executes the instructions stored in the memory, the processor,
generates an AUTOSAR platform area on the virtual ECU operating in a virtual environment through a predetermined emulator,
generates a memory area on the virtual ECU, and
as an input/output command transmitted from the AUTOSAR platform area is received through the memory area, generates a peripheral in a core area of the virtual ECU performing a read or write operation of data on a register of a peripheral by emulating an operation corresponding to the input/output command.
